(19) United States
(12) Patent Application Publication
(10) Pub. No.: US 2023/0380948 A1
(43) Pub. Date: Nov. 30, 2023

(54) NOVEL STRUCTURE OF AN ELECTRIC CYLINDRICAL-ROTATION AND IN-LINE SWEEPING TOOTHBRUSH

(71) Applicant: Jian Leng NG, Singapore (SG)

(72) Inventor: Jian Leng NG, Singapore (SG)

(21) Appl. No.: 17/949,368

(22) Filed: Sep. 21, 2022

(30) Foreign Application Priority Data
May 24, 2022 (SG) 10202205470U

(51) Int. Cl. A61C 17/26; A61C 17/34; A46B 13/02; A61C 17/22

(52) U.S. Cl. CPC A61C 17/26; A61C 17/3418; A46B 13/026; A61C 17/221

(57) ABSTRACT

An electric cylindrical-rotation and in-line sweeping toothbrush is disclosed. The electric cylindrical-rotation and in-line sweeping toothbrush having a rotating shaft, a handle and a motor comprising:
a first portion having perpendicular bristles to the rotation axis of the rotating shaft that includes at least one rotating head with bristles thereon; wherein the perpendicular bristles located on the rotating shaft and the rotation axis in rotation of the rotating shaft sweeps the whole length of the bristles section against the section of teeth in the same manner, and the toothbrush provides consistent sweeping from the gum towards the tip of the teeth in every part of the whole set of teeth.

### BACKGROUND OF THE INVENTION

### 1. Field of the Invention

The present invention relates to electric toothbrushes and, more particularly, is concerned with a toothbrush of which the sweeping thereof from gum to the tip of the teeth being consistent across all the bristles of the toothbrush.

### 2. Description of the Prior Art

Known prior art electric toothbrushes typically include a handle, a drive unit mounted in the handle and having a drive shaft extending to an end of the handle, and a brush head rotatably supported at the end of the handle and driven via a driving linkage to the drive shaft such that a cleaning or brushing plane formed by ends of bristles of the brush head is set to undergo a rotary turning motion for cleaning a set of teeth. The typical drive unit in the handle includes an electric motor and a battery providing a source of voltage to operate the electric motor.

In these known prior art electric toothbrushes, the brush head is supported for undergoing rotation about an axis extending perpendicular to the cleaning or brushing plane of the brush head. In some of these prior art electric toothbrushes, the brush head is setup to undergo an oscillatory turning motion in which the brush head swivels in one direction through a preset angle, for example of seventy degrees, and subsequently through the same preset angle in the opposite direction.

In the case of toothbrushes whose brush head is driven to exert the oscillatory turning motion, the efficiency of the energy made available by the battery is lower than in such toothbrushes whose brush head carries out a rotary turning motion since, due to the reversal of the regular movement, dead points at the opposite ends of the oscillatory path must be overcome which is energy consuming.

In other of these prior art electric toothbrushes, the brush head is setup to undergo continuous rotation in one direction about its rotational axis extending at a right angle to the brushing plane of the brush head.

Numerous attempts have been made to improve the design and cleaning efficacy of electric toothbrushes. One approach has been the provision of multiple powered bristle carriers. Exemplary designs include those disclosed in U.S. Pat. Nos. 3,242,516; 4,156,620; 4,845,795; 5,088,145; 5,020,179; 4,827,550; and 4,545,087. Further known devices are shown in U.S. Pat. Nos. 5,070,567; 5,186,627; 5,274,870; 5,341,534; 5,378,153; and 5,732,433.

U.S. Pat. No. 5,070,567 describes a design combining the two previously noted strategies. A rotating bristle carrier is provided along with multiple individually rotatable bristle sets. Although this design likely provides many of the advantages associated with each of its predecessors, the cleaning efficacy of spinning bristle sets, alone, is somewhat limited.

There are a few reasons that the unique toothbrush of the present invention is designed and that the present invention provides best effectiveness and never been done or seen in the market. A 7 years old kid has difficulty in brushing the teeth at different sides of the teeth, especially the bottom inner left and the right top and bottom inner teeth. The twisting part is difficult and the moving up and down will tend to slip and hit his teeth with the hard part of the toothbrush. Many part of the teeth have been missed out and are unclean. On the market different type of toothbrushes are with different functionality. For instance, the Ultrasonic and the rotating type (Bristles rotate in parallel to the rotating axis). For the ultrasonic type, user still needs to use hand to swipe up and down or sideways. It is merely vibrating the bristles. For the rotating type, one portion is sweeping from gum to teeth while the other is from teeth to gum. The sweeping action from teeth to the gum is not recommended as it might hurt our gum.

It has been taught to sweep the bristles of the toothbrush from gum towards the tip of the teeth counting more than 5 times per section of brushing whole teeth by dentist. It will take some effort to do it correctly and accurately by twisting the wrist or moving the tooth brush up and down and it is not easy especially for a child. What make it worst is that the user may have difficulty producing the same effect at different part of our teeth. Doing this repeatedly every section including clockwise and anti-clockwise rotation of the brush using the wrist is tedious and inaccurate.

The intention of the present invention is to provide a motorized toothbrush wherein the bristles can have consistent brushing in the direction from gum to the teeth tip. The toothbrush in accordance with the present invention provides sweeping movement of the bristles from gum to the tip of the teeth being in consistent across all the bristles of the toothbrush. The automatic sweeping will replace the tedious twisting of using wrist or motion of up and down, making it much effortless and effective that children will also be able to brush like a dentist does.

### SUMMARY OF THE INVENTION

The present invention overcomes the aforementioned problems by providing an electric toothbrush which includes a handle, a bristles hub, rotating shaft, a motor to undergo movement along an endless path of revolution having an axis of revolution extending substantially parallel to the brushing plane such that the brushing plane is maintained in the same orientation relative to a surface of a set of teeth throughout movement of the brush head. Such brush head so provided on an electric toothbrush ensures a highly efficient utilization of the available electrical energy as well as the attainment of a more even and thus improved brushing result.

A main object of the present invention is to provide an electric cylindrical-rotation and in-line sweeping toothbrush having a rotating shaft, a handle and a motor comprising:
a first portion having perpendicular bristles to the rotation axis of the rotating shaft that includes at least one rotating head with bristles thereon; wherein the perpendicular bristles located on the rotating shaft and the rotation axis in rotation of the rotating shaft sweeps the whole length of the bristles section against the section of teeth in the same manner, and the toothbrush provides consistent sweeping from the gum towards the tip of the teeth in every part of the whole set of teeth.

Still a further object of the present invention is to provide an electric cylindrical-rotation and in-line sweeping toothbrush, wherein the bristles are positioned on to the distant end of the rotating shaft and rotate perpendicularly about the rotating axis of the rotating shaft.

Yet a further object of the present invention is to provide an electric cylindrical-rotation and in-line sweeping toothbrush, wherein the bristles sweep vertically along the teeth gap and the bristles sweep vertically against the teeth of a user, and the toothbrush moves in and out of the joint of the gum and the teeth area.

Yet still another object of the present invention is to provide an electric cylindrical-rotation and in-line sweeping toothbrush, wherein the axis of rotation of the bristles is in-line with the rotation axis of the rotating shaft and the toothbrush sweeping is a in-line sweeping covering the full stroke of the whole teeth.

A further object of the present invention is to provide an electric cylindrical-rotation and in line sweeping toothbrush, wherein the in-line sweeping is the sweeping of the gum and moving along the teeth towards the end of the teeth and the sweeping includes clockwise and anti-clockwise rotation of the bristles of the toothbrush.

Still yet another object of the present invention is to provide an electric cylindrical-rotation and in line sweeping toothbrush, wherein the speed of rotation speed varies 1/360 revolution to 1 revolution per second.

It is another object of the present invention to provide an electric cylindrical-rotation and in line sweeping toothbrush, wherein a full sweeping employs a molded tooth brush onto a small conveyor belt.

Yet another object of the present invention is to provide an electric cylindrical-rotation and in line sweeping toothbrush, wherein the rotation of the motor shaft drives the belt to ensure the sweeping of the full length of the tooth.

Still another object of the present invention is to provide an electric cylindrical-rotation and in line sweeping toothbrush, further comprising a bristle's hub, wherein the hub is of hollowed construction.

These together with additional objects, features and advantages of the electric toothbrush will be readily apparent to those of ordinary skill in the art upon reading the following detailed description of the presently preferred, but nonetheless illustrative, embodiments when taken in conjunction with the accompanying drawings.

It is therefore important that the claims be regarded as including such equivalent construction insofar as they do not depart from the spirit and scope of the electric toothbrush. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a schematic sectional view of an electric cylindrical-rotation and in-line sweeping toothbrush in accordance with the present invention, wherein the ON/OFF button as viewed from one side of the toothbrush is shown.

FIG. 2 is a schematic sectional view of an electric cylindrical-rotation and in-line sweeping toothbrush in accordance with the present invention, wherein the directional switch as viewed from one side of the toothbrush is shown.

FIG. 3A is a schematic perspective view of Type I refill for the electric cylindrical-rotation and in-line sweeping toothbrush in accordance with the present invention.

FIG. 3B is the front view of Type I refill for the electric cylindrical-rotation and in-line sweeping toothbrush in accordance with the present invention.

FIG. 4A is a schematic perspective view of Type II refill for the electric cylindrical-rotation and in-line sweeping toothbrush in accordance with the present invention.

FIG. 4B is the front view of Type II refill for the electric cylindrical-rotation and in-line sweeping toothbrush in accordance with the present invention.

FIG. 5 is a schematic view showing the slanted bristles reaching the behind of the back tooth.

FIG. 6A is a schematic perspective view of Type III refill for the electric cylindrical-rotation and in-line sweeping toothbrush, showing an anti-clockwise direction, in accordance with the present invention.

FIG. 6B is the front view of Type III refill for the electric cylindrical-rotation and in-line sweeping toothbrush in accordance with the present invention, showing swiping downward against the teeth direction.

FIG. 7A is a schematic perspective view of Type IV refill for the electric cylindrical-rotation and in-line sweeping toothbrush, showing an anti-clockwise direction, in accordance with the present invention.

FIG. 7B is the side view of Type IV refill for the electric cylindrical-rotation and in-line sweeping toothbrush in accordance with the present invention.

FIG. 8A is a schematic perspective view of Type IV refill for the electric cylindrical-rotation and in-line sweeping toothbrush, showing rotation sweeping against the teeth, in accordance with the present invention.

FIG. 8B is the side view of Type IV refill for the electric cylindrical-rotation and in-line sweeping toothbrush, showing rotation sweeping against the teeth, in accordance with the present invention.

FIG. 9 is a side view of the Type IV bristles brush the behind of the teeth in accordance with the present invention.

FIG. 10A is a perspective view of the electric cylindrical-rotation and in-line sweeping toothbrush, in accordance with the present invention.

FIG. 10B is another perspective view of the electric cylindrical-rotation and in-line sweeping toothbrush in accordance with the present invention.

FIG. 11 is a schematic view of the cover for shielding the mouth from the tooth brush when using the toothbrush in accordance with the present invention.

FIG. 12A is a front view showing consistent sweeping of the teeth throughout the full section of the toothbrush in accordance with the present invention.

FIG. 12B is a side view of the sweeping of the teeth in accordance with the present invention.

FIG. 13A is the front view of how the toothbrush contact with the teeth in accordance with the present invention.

FIG. 13B is the side view of how the toothbrush contact with the teeth in accordance with the present invention.

FIG. 14 is a perspective view showing the in-line sweeping of the electric brush in accordance with the present invention.

FIG. 15 is a perspective view showing the bristles in the bristles holder in accordance with the present invention.

FIG. 16A is a perspective view of a standard brush showing refill with slanted bristles in accordance with the present invention.

FIG. 16B is a perspective view of a standard brush showing refill without slanted bristles in accordance with the present invention.

FIG. 17A is a perspective view of an embodiment with conveyor type of refill showing refill with slanted bristles in accordance with the present invention.

FIG. 17B is a perspective view of an embodiment with conveyor type of refill showing refill without slanted bristles in accordance with the present invention.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

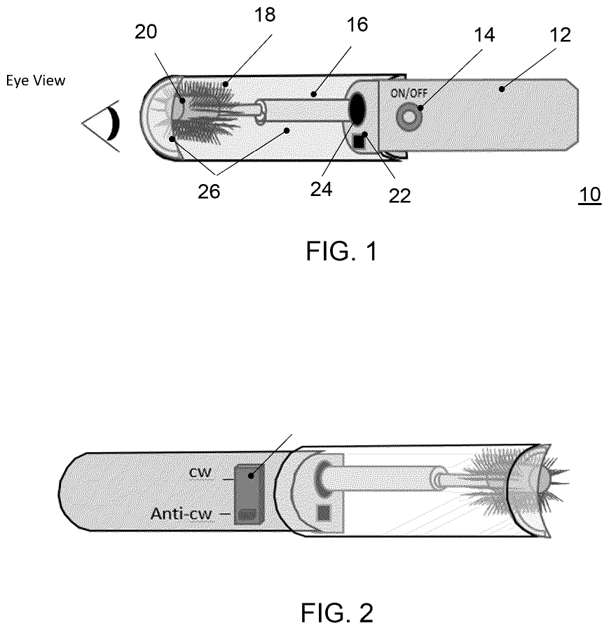

Detailed reference will now be made to a first potential embodiment of the disclosure, which is illustrated in FIGS. 1 through 17B. The electric toothbrush (10) comprises a handle (12) having a ON/OFF switch (14), a rotating shaft (16) having bristles (18) at a distant end of the shaft (16), and a bristle hub (20) is used as the base for the upper portion of the toothbrush (10).

FIG. 1 is a schematic sectional view of an electric cylindrical-rotation and in-line sweeping toothbrush in accordance with the present invention, wherein the ON/OFF button as viewed from one side of the toothbrush is shown. In accordance with the present invention, the toothbrush (10) when in use, the sweeping of the toothbrush (10) from gum to the tip of the teeth will be consistent across all the bristles of the toothbrush. The automatic sweeping will replace the tedious twisting of the user's wrist or motion of up and down, making it much effortless and effective that children will also be able to brush like doctors.

FIG. 1 and FIG. 2 show the different side of the toothbrush of the present invention, both being installed with a Type 1 Refill. FIG. 2 is a schematic sectional view of an electric cylindrical-rotation and in-line sweeping toothbrush in accordance with the present invention, wherein the directional switch as viewed from one side of the toothbrush is shown.

In accordance with the preferred embodiment of the present invention, there are a total of 4 types of refills that can be used in the toothbrush (10) of the present invention.

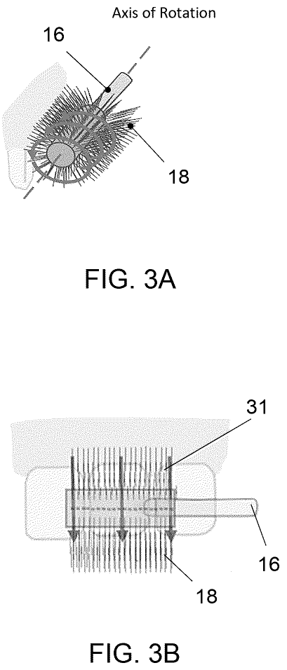

FIG. 3A is a schematic perspective view of Type I refill for the electric cylindrical-rotation and in-line sweeping toothbrush in accordance with the present invention. As shown in FIG. 3A, the schematic perspective view of type 1 refill rotates about the axis of rotation, where the bristles (18) are sweeping against the gum of the teeth. The full range of the bristles (18) is in operation in the course of sweeping of the teeth.

FIG. 3B is the front view of Type I refill for the electric cylindrical-rotation and in-line sweeping toothbrush (10) in accordance with the present invention. The arrow (31) shown in FIG. 3B is the direction of the bristles (18) in operation.

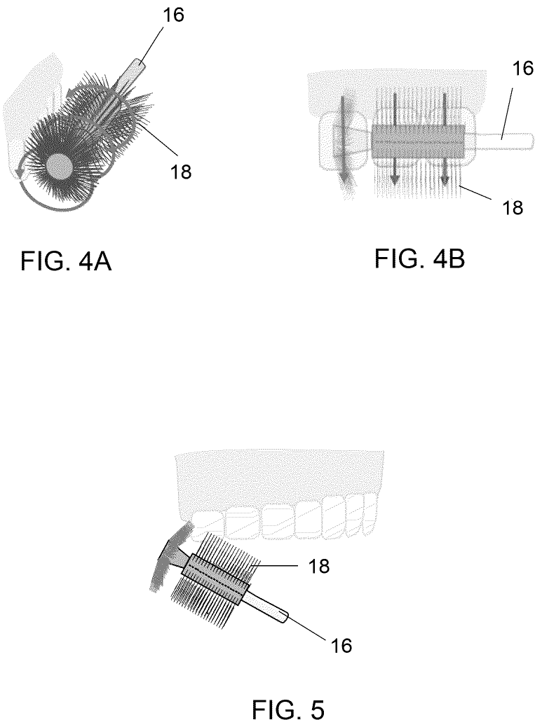

FIG. 4A is a schematic perspective view of Type II refill for the electric cylindrical-rotation and in-line sweeping toothbrush in accordance with the present invention.

FIG. 4B is the front view of Type II refill for the electric cylindrical-rotation and in-line sweeping toothbrush in accordance with the present invention. The end of the bristles (18) is used for sweeping the back of the tooth that is difficult to reach. The range of the bristles (18) is perpendicular to the rotating shaft (16).

FIG. 5 is a schematic view showing the slanted bristles reaching the behind of the back tooth. In accordance to the preferred embodiment of the present invention, the bristles (18) for type II refill can be used to sweep the behind of the back tooth. As shown in FIG. 5, the bristles (18) is able to sweep the area behind the back tooth.

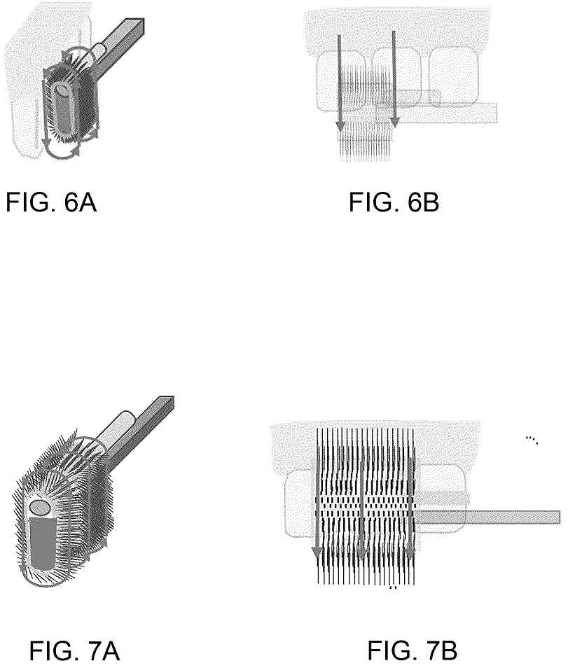

FIG. 6A is a schematic perspective view of Type III refill for the electric cylindrical-rotation and in-line sweeping toothbrush, showing an anti-clockwise direction, in accordance with the present invention. As shown the bristles (18) are mounted on a conveyor belt, and the arrow indicates the rotation of the belt. The bristles (18) is able to sweep the teeth downward and against the teeth.

FIG. 6B is the front view of Type III refill for the electric cylindrical-rotation and in-line sweeping toothbrush in accordance with the present invention, showing swiping downward against the teeth direction. FIG. 7A is a schematic perspective view of Type IV refill for the electric cylindrical-rotation and in-line sweeping toothbrush, showing an anti-clockwise direction, in accordance with the present invention.

FIG. 7B is the side view of Type IV refill for the electric cylindrical-rotation and in-line sweeping toothbrush in accordance with the present invention.

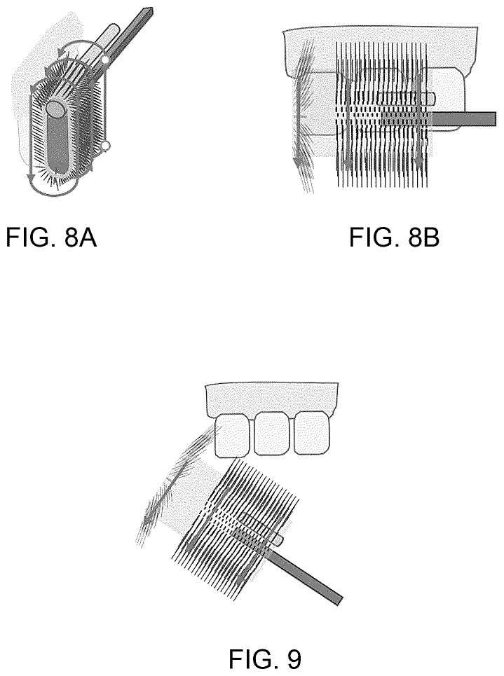

FIG. 8A is a schematic perspective view of Type IV refill for the electric cylindrical-rotation and in-line sweeping toothbrush, showing rotation sweeping against the teeth, in accordance with the present invention.

FIG. 8B is the side view of Type IV refill for the electric cylindrical-rotation and in-line sweeping toothbrush, showing rotation sweeping against the teeth, in accordance with the present invention.

FIG. 9 is a side view of the Type IV bristles brush the behind of the teeth in accordance with the present invention.

In accordance with the present invention, in order for the bristles to perform the sweeping process, the user just ensure that the rotation is sweeping from gum to the tip. Change the direction of switch position if it is not correct. The present invention provides in-line sweeping toothbrush refill. This has the same rotational function but with the additional length of bristles.

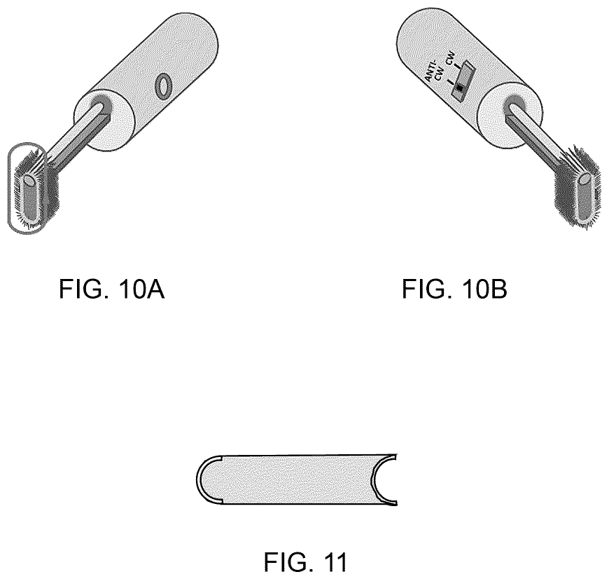

FIG. 10A is a perspective view of the electric cylindrical-rotation and in-line sweeping toothbrush, in accordance with the present invention.

FIG. 10B is another perspective view of the electric cylindrical-rotation and in-line sweeping toothbrush in accordance with the present invention.

### Overview and Operation of the Cylindrical-Rotation and In-Line Sweeping Toothbrush

### Cylindrical-Rotation Type

Referring to FIGS. 3A and 3B for the design and layout of the motorized cylindrical-wise rotation toothbrush. The rotation will sweep the bristles into the gum out from the tip of the teeth and not from the teeth into the gum. It also simulating our normal brushing using our wrist. There are rows of bristles and covers 360 degrees of the bristle's hub. Likewise for the conveyor type of bristles. User need to switch the rotation direction for other part of the teeth to have the same sweeping action.

### In-Line Sweeping (Conveyor Belt) Type

Referring to FIGS. 3A, 3B and 4A, 4B and FIG. 5 for the design and layout of the motorized cylindrical-rotation toothbrush. There are rows of bristles covering the whole conveyor belt as shown. Every row of bristles will sweep followed by subsequent row of bristles. The brush bristles move along with the conveyor sweeping the teeth from the gum all the way to the end of the teeth. The bristlers molded to the conveyor will automatically sweep the whole teeth section that it contacts without the user needing to move up and down. The sweeping of the bristles goes into the gum and all the way to the end of the teeth. User needs to switch the rotation direction for other part of the teeth to have the same sweeping action.

FIG. 11 is a schematic view of the cover for shielding the mouth from the tooth brush when using the toothbrush in accordance with the present invention.

In accordance with the present invention, the toothbrush comprises Motor: 3.7 V, power switch: push button latch ON/OFF, directional switch: 2 sets of 2 poles double throw, battery casing: 2 slots with inverse polarity, Handle holding the battery, switches, circuit board, battery casing and the motor, separator cover (Half circular) to prevent brush from sweeping against the mouth, brush type 1. Bristles on a cylindrical hub. Socket holding the bristle's hub and for inserting to the rotating shaft (Rotating shaft driven by the motor), brush type 2. Bristles molded to the mini conveyor belt with gears in the inner part of the belt that will engage with the driving gear. Cylindrical hub with gear for driving the conveyor belt. Conveyor belt sliding block that act as the surface for the belt to slide and guided to prevent slipping to the side.

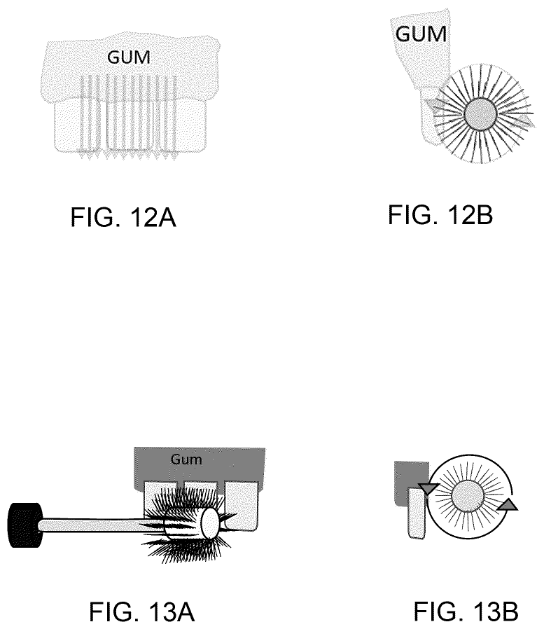

FIG. 12A is a front view showing consistent sweeping of the teeth throughout the full section of the toothbrush in accordance with the present invention. FIG. 12B is a side view of the sweeping of the teeth in accordance with the present invention.

This unique and only one in the world toothbrush with perpendicular bristles to the rotation axis sweeps the whole length of the bristles section against the section of teeth in the same manner whereas those in the market which rotates parallel to the rotation axis does not have the effective inner radius section of the bristles functioning as its outer radius bristles. This is because the current type has the outer bristles sweeps in bigger circumference but the inner radius has as small circumference.

This revolution idea of perpendicular sweeping bristles definitely make it the unique and the only tooth brush in the world that can sweep like the dentists' recommendation. This unique toothbrush definitely provides helps everyone especially kids to sweep like what dentists' recommend and definitely better, as it sweeps more times effortlessly. This is the only toothbrush that has consistent sweeping the from gum towards the tip of the teeth in every part of the whole set of teeth as compared to currently in the market where it sweeps from teeth into the gum at one portion but the other way round at another. This toothbrush definitely met the dentist's brushing recommendation. The uniqueness of the toothbrush provides unique brushing of teeth that stands out as no other toothbrush that will be able sweep as effective as this. This outstanding toothbrush not only has the effectiveness as doctor's method of brushing, it also eliminates the fatigue of twisting the wrist or the motion of moving the toothbrush up and down. With this revolutionary toothbrush, it will definitely attract more people especially kids to love brushing their teeth and will promote more healthy teeth throughout the world.

FIG. 13A is the front view of how the toothbrush contact with the teeth in accordance with the present invention.

FIG. 13B is the side view of how the toothbrush contact with the teeth in accordance with the present invention.

Electric cylindrical rotational and in-line sweeping toothbrush comprising:

The bristles rotates perpendicularly about the motor axis as shown in FIG. 12.

It sweeps vertically along the teeth gap.

It sweeps the brush against teeth. The toothbrush will move in and out of the joint of the gum and the teeth area. The brushes behind will follow in and whole process will repeat in a circular motion but the axis of rotation is in-line with the motor axis.

This toothbrush sweeping comprises of in-line sweeping covering the full stroke of the whole teeth. The in-line sweeping meaning it sweep from the gum and move along the teeth towards the end of the teeth. The claim also include the toothbrush irregardless of how many teeth the brush covers. So it will be an infringe of this patent even it its design covers one to any number of teeth because it function covers the sweeping of the teeth from the gum to the teeth tips. See below FIG. 3 for the graphical representation of the description above.

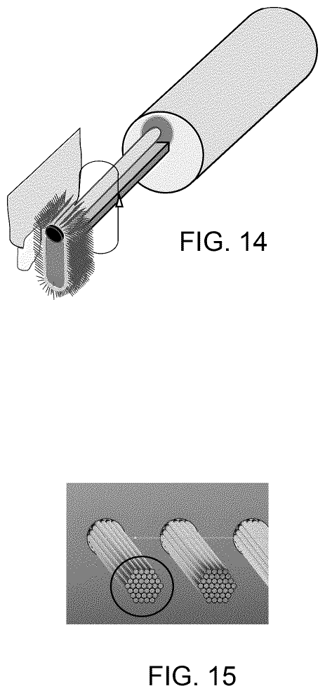

FIG. 14 is a perspective view showing the in-line sweeping of the electric brush in accordance with the present invention.

This design of the toothbrush means no one is allowed to use this or similar sweeping method that stroke the brush from the gum to the end of the tooth by either the point contact or the full stroke method of the toothbrush. The protection includes the clockwise or anti-clockwise rotation of the brush. The rotation speed are variable from 1 degrees of revolution per second to 360 degrees per second. The infringement covers any speed using the sweeping method stated in the design. The full sweeping uses the molded tooth brush onto the small conveyor belt as shown below. The rotation of the motor shaft drives the belt along the flat surface that ensure the sweeping of the full length of the tooth.

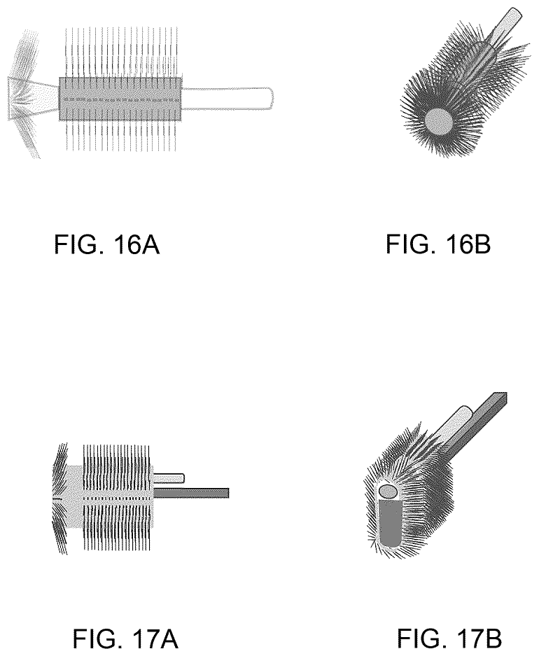

FIG. 15 is a perspective view showing the bristles in the bristles holder in accordance with the present invention. FIG. 16A is a perspective view of a standard brush showing refill with slanted bristles in accordance with the present invention. FIG. 16B is a perspective view of a standard brush showing refill without slanted bristles in accordance with the present invention.

How the toothbrush is produced.

Prefab each bristle at 0.015 mm in diameter (nylon or similar materials). There will be 37 bristles packed and inserted into each hole on the bristles holder. Bristle on refill with and without the slanted bristles for the standard brush. There will be rows of holes (each to hold the pack of bristles) line up horizontally along the main body. For the end body there are bristles packed along the holes as shown in FIG. 16b. Below shows the refill with slanted end bristles. Same configuration goes for the refill without the end bristles (slanted bristles). There are 8 holes in a row (each hole holds 37 bristles) and 117 rows over the 3600 revolution of the body. These bristles at the end of the toothbrush are for the back of the hard to reach back tooth.

FIG. 16A is a perspective view of a standard brush showing refill with slanted bristles in accordance with the present invention. FIG. 16B is a perspective view of a standard brush showing refill without slanted bristles in accordance with the present invention.

Bristle on refill with and without the slanted bristles for the conveyor type of refill. The bristles will be molded onto the rubber material belt instead of inserted and glued to the holes like the standard refill type

FIG. 17A is a perspective view of an embodiment with conveyor type of refill showing refill with slanted bristles in accordance with the present invention.

FIG. 17B is a perspective view of an embodiment with conveyor type of refill showing refill without slanted bristles in accordance with the present invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

1. An electric cylindrical-rotation and in-line sweeping toothbrush having a rotating shaft, a handle and a motor comprising:
a first portion having perpendicular bristles to the rotation axis of the rotating shaft that includes at least one rotating head with bristles thereon; wherein the perpendicular bristles located on the rotating shaft and the rotation axis in rotation of the rotating shaft sweeps the whole length of the bristles section against the section of teeth in the same manner, and the toothbrush provides consistent sweeping from the gum towards the tip of the teeth in every part of the whole set of teeth.

2. The electric cylindrical-rotation and in-line sweeping toothbrush as set forth in claim 1, wherein the bristles are positioned on to the distant end of the rotating shaft and rotate perpendicularly about the rotating axis of the rotating shaft.

3. The electric cylindrical-rotation and in-line sweeping toothbrush as set forth in claim 1, wherein the bristles sweep vertically along the teeth gap.

4. The electric cylindrical-rotation and in-line sweeping toothbrush as set forth in claim 1, wherein the bristles sweep vertically against the teeth of a user, and the toothbrush moves in and out of the joint of the gum and the teeth area.

5. The electric cylindrical-rotation and in-line sweeping toothbrush as set forth in claim 1, wherein the axis of rotation of the bristles is in-line with the rotation axis of the rotating shaft.

6. The electric cylindrical-rotation and in line sweeping toothbrush as set forth in claim 1, wherein the toothbrush sweeping is a in-line sweeping covering the full stroke of the whole teeth.

7. The electric cylindrical-rotation and in line sweeping toothbrush as set forth in claim 6, wherein the in-line sweeping is the sweeping of the gum and moving along the teeth towards the end of the teeth.

8. The electric cylindrical-rotation and in line sweeping toothbrush as set forth in claim 1, wherein the sweeping includes clockwise and anti-clockwise rotation of the bristles of the toothbrush.

9. The electric cylindrical-rotation and in line sweeping toothbrush as set forth in claim 1, wherein the speed of rotation speed varies 1/360 revolution to 1 revolution per second.

10. The electric cylindrical-rotation and in line sweeping toothbrush as set forth in claim 1, wherein a full sweeping employs a molded tooth brush onto a small conveyor belt.

11. The electric cylindrical-rotation and in line sweeping toothbrush as set forth in claim 10, wherein the rotation of the motor shaft drives the belt to ensure the sweeping of the full length of the tooth.

12. The electric cylindrical-rotation and in line sweeping toothbrush as set forth in claim 1, further comprising a bristle's hub, wherein the hub is of hollowed construction.
